(19) United States
(12) Patent Application Publication
(10) Pub. No.: US 2014/0162745 A1
(43) Pub. Date: Jun. 12, 2014

(54) Method and apparatus for playing at least one video card game

(71) Applicant: Henry Tien Lo, Las Vegas, NV (US)

(72) Inventor: Henry Tien Lo, Las Vegas, NV (US)

(21) Appl. No.: 13/998,727

(22) Filed: Nov. 26, 2013

Related U.S. Application Data
(60) Provisional application No. 61/797,004, filed on Nov. 26, 2012.

(51) Int. Cl. G07F 17/32

(52) U.S. Cl. CPC G07F 17/3262
USPC 463/11

(57) ABSTRACT

In any given round of play, a player can play one or more of new and existing video card games simultaneously, largely games of chance, with at least one provided options: option of selecting one or more of the player's favorite games to play, option of selecting use of single deck of cards or use of multiple decks of cards, option of selecting one hand or up to the maximum number of hands that a player is allowed to play, After the player selects a desired amount of denomination, chooses at least one of the options, and places a bet, the player then starts the game play; the machine will then shuffle the cards and deals a hand of at least one card on the screen of the machine, it determines whether the player's bet wins or loses and pays the player's winning bet according to rules of the game.

### CROSS REFERENCE TO RELATED APPLICATION

This application claims the benefits under 35 U.S.C. §119(e) from the following provisional patent application Ser. No. 61/797,004, filed Nov. 26, 2012.

### BACKGROUND OF THE INVENTION

This invention relates to multiple-hand wagering games. In particular, it relates to a method and apparatus for playing at least one video card game against a pay table.

There are many wagering video poker games used for gambling and playing for fun. Among them are draw poker games of single play or single hand, including Jack or Better, Double Double Bonus, Super Aces Bonus, Deuces Wild, Triple Double Bonus.

In Jack Better game, after a player make his or her bet and hit the draw spot or button, the machine will then deal a hand of five cards on the screen, and the player may hold one or up to five cards, or the player discards all five cards, and then hit “Draw” button to play out the hand; if the final hand shows a pair of Jack or better, the player's bet wins and is paid according to a predetermined pay table; if the final hand shows no pair of Jack or better, the player's bet gets no pay. In Super Aces Bonus, it is played like Jack or Better, but if the final hand shows a pair of Jack or better, the player's bet wins and is paid according to a predetermined pay table, wherein 4 Aces pays 2000 for 1, five times of 4 Aces pays in Jack or Better. In Deuces Wild game, Deuce card is wild and may be used as any card; it is played like Jack or Better, but if the final hand has 3 of a Kind or better, the player's bet wins and is paid according to a predetermined pay table.

Usually, only time a player wins money from those games is when he hit at least one big bonus hand or jackpot hand like a Royal Flush or 5 Aces with a kicker (in Double Double Bonus poker and Triple Double Bonus poker), and the chances of hitting a Royal Flush is about 1 out of 40,000 hands, and 5 Aces with a kicker about 1 out of 14,000 hands; often, a player can play days or weeks without hitting one of those hands.

To increase the chances of hitting big jackpot hands, games with multiple-play option such as triple-play, five-play, ten-play, fifty-play, and even hundred-play slots were invented by Ernie Moody. In a triple-play version of Jack or Better game, after a player places a bet and activates “Draw” or “Start” button; the machines then deals three 5-card hands on the screen, hand 1 is face up and hand 2 and 3 face down; and the player may hold one or up to five cards, or the player discards all five cards, hand 2 and 3 will be exactly like whatever the hand 1 is after the player decides, the player then hit “Draw” button to play out the hand; if any final hand shows a pair of Jack or better, the player's bet wins and is paid according to a same predetermined pay table. Although those multiple-play slots do improve a player's winning chances, still a significant number of regular players and new players are rather staying away from those games, because it and other aforementioned games, are fun to play, yet all are games of skill, and most players do not know how to play them properly and don't want to spend a great deal of time and effort to learn and practice to play it properly.

A very popular video card game presently being played in casinos over the country, called “3-Way Action,” offers three games in one. In this whole game, after a player makes a bet, the machine then deals five card face up as the first game, which plays like five card stud; and the player may hold one or up to five cards of the first game, or the player hold no card, and then hit “Draw” button to play out second hand of the whole game, which is played like five cards draw; finally the machine deals out two more cards face up, these two cards plus five final cards of second game becomes seven final cards of third game, which is played like seven cards stud. If hand 1 or five card stud is pair of 3 or better, the player's hand-1 bet wins and is paid according first predetermined pay table; if hand 2 or five card draw is a pair of Jack or better, the player's hand-2 bet wins and is paid according to second predetermined pay table; if hand 3 or seven card stud is 3 of a Kind or better, the player's hand-3 bet wins and is paid according to third predetermined pay table. Although, the game play of hand 1 required no skill, the player do need special playing strategy, which is largely different than normal playing strategy for similar five card stud, to play properly because the player must also consider what decision will likely produce a better result for the game of hand 2 and for the game of hand 3 as well. Because of this difficulty, the slot operators gain more advantage over the players.

Almost all of aforementioned games are games of skill; in order to reduce the house advantage, a player must learn and play according to individual optimal strategy. Since these games are played with single deck of cards; when a player is unhappy with the game or machine, the player will have the trouble to look around for another machine of the same game, and might become angry when there is a shortage of the machine. Many players feel lack of sense of control because game designs and games offered today do not provide players the option of choosing many of a player's favorite games to play simultaneously, the option of selecting any particular hand or hands to play from a pool of limited dealt hands, the option of replace the game or the main game (the main hand of multiple play version) with one of multiple decks of cards.

### SUMMARY OF THE INVENTION

In any given round of play, the method and apparatus for playing multiple video card games of the present invention involving at least one player is played as follows:

1. A slot machine or a computer or an electronic device, hereinafter defined as “the machine,” is used, which is programmed or configured to run, manage, and complete game plays of games of single-game play (wherein only one video card game may be played in any given round of play), as well as game plays of various card games of multiple-games play simultaneously (wherein one or more various games may be played simultaneously in any given round of play).

2. The player may select a denomination he or she wants to play from a list of various amounts, such as a list of 5¢, 100¢, 250¢, 500¢ and $1.

3. The player may choose either a pool of video card games of single-game play or a pool of various video card games of multiple-game play to play. The pool of video card games of single-game play preferably contains games that include at least one player hand and one banker hand, such as 7-Card Thrill Video Game and Wild 7-Card Thrill. The pool of various video card games of multiple-game play preferably contains games of chance, such as Wild 7-Card Stud, 5-Card Stud, 7-Card Stud, 6-Card Stud, and 4-Card Stud. All said games will be fully disclosed in Detailed Description of the Invention.

4. The player buys or gets game credits for to be used for making bets;

5. The player may select use of single deck of cards or use of multiple separate decks of cards (electronic cards, not physical cards).

6. The player may choose to play one hand or up to the maximum number of hands that the player is allowed to play with one of player's favorite games from the pool of games of single-game play, may choose to play one or more of the player's favorite games simultaneously or up to the maximum number of games that the player is allowed to play from the pool of various games of multiple-game play. In the single-game play played with single deck of cards, the player may himself select any particular player hand or hands the player wants to play, as well as a hand to be a banker hand from a pool of dealt hands or the player may have the machine do the selection.

7. The player places bet or bets (with betting credit or betting units).

8. The player activates or starts the game play.

9. The machine deducts the total betting credits or total betting units from the credit score or available credit.

10. The machine deals face-up cards on the screen.

11. If the game play requires the player to make any appropriate decision, such as discarding cards and drawing cards, folding or playing out the hand, arranging the cards into a number of hands, the player must complete the requirement(s); if not, move to step 12.

12. The machine determines whether each of the player's hands wins or loses according to rules of the game.

13. The machine settles or resolves the player's bet or bets; wherein each of the player's losing bets gets no pay; wherein each of the player's winning bets is paid preferably according to a predetermined pay table. And

14. The machine adds the player's winning credits to the player's credit score.

15. Either the Option of Using an Amazing Pool of Multiple Decks of Cards or the Option of Using a Pool of Other Identical Games is shown on the screen and is available for the player to choose for next new play after the completion of the play (when the player wants to change the machine).

The pool of various games of multiple-game play used in step 3 are games of chance, no skill is needed; this feature would highly appeal to new players as well as players who do not like games that require skill to play. Giving the player the options of selecting use of single deck of cards and use of multiple separate decks of cards in step 5 would give the player a strong sense of control. In step 6, the player may choose to play as many hands as the player wants with one of the player's favorite games, and may select one or more of the player's favorite games to play simultaneously; the options in step 6 would significantly increase the player's chance of hitting big bonus hands and would make the player feel like the machine is made for him or her as well. Choosing either option in step 15 would save both a player the trouble looking around for another machine of the same game and the slot operators the high cost and valuable space of carrying additional machines for that reason.

The objective of the present invention is to provide a player a simple, unique and fun way to enjoy playing the player's favorite games with many player favorable options, making the player feel that he or she is so much in control of the game play, and the machine is made for him or her as well.

### BRIEF DESCRIPTION OF THE DRAWINGS

FIG. 1 illustrates the first slot or computer or electronic device screen of a video card game in accordance with the present invention.

FIG. 2 may be the second slot or computer or electronic screen of a video card game of the present invention when the player chooses the option single-game play on the first screen of the game in FIG. 1

FIG. 3, like FIG. 2, may be the second slot or computer screen of a video card game of the present invention when the player selects the option of multiple-game play on the first screen of the game in FIG. 1.

FIG. 4 is a perspective view of a video card poker game slot machine of the present invention.

FIG. 5 discloses the flow of play of the present invention.

### DETAILED DESCRIPTION OF THE INVENTION

The method and apparatus for playing at least one video card game of the present invention encompasses at least one player, uses of things including the use of a machine that may be a slot machine or a computer or an electronic device, the use of at least one video card game, the use of at least one standard poker deck of electronic cards (not physical cards), the rules of playing a game of single-game play, the rules of playing at least one game of multiple-game play, preferred embodiments, and rules of new and existing video card games.

At Least One Player:

This invention involves at least one player, preferably one player.

The Use of a Slot Machine:

The method and apparatus for playing at least one video card game on a slot machine or an electronic device uses an apparatus. The apparatus includes a slot machine using at least one video card game and at least one deck of cards (electronic cards, not physical cards), a screen or monitor, a key panel or keyboard, cash and credit ticket insert slot, credit printing slot.

The slot machine or computer processor of the apparatus must have the capability or is programmed to electronically and randomly shuffle one deck of cards and/or two or more individual decks of cards simultaneously, to deal out a number of selected hands of predetermined number of cards at any given round of play, to determine whether the bet or bets win or lose, to settle the wager or wagers of the winning bet or bets and of losing bet or bets, to keep track of the player's credit score, and to display and print out available credit.

The screen or monitor of the slot constitutes any or all of the following spot:

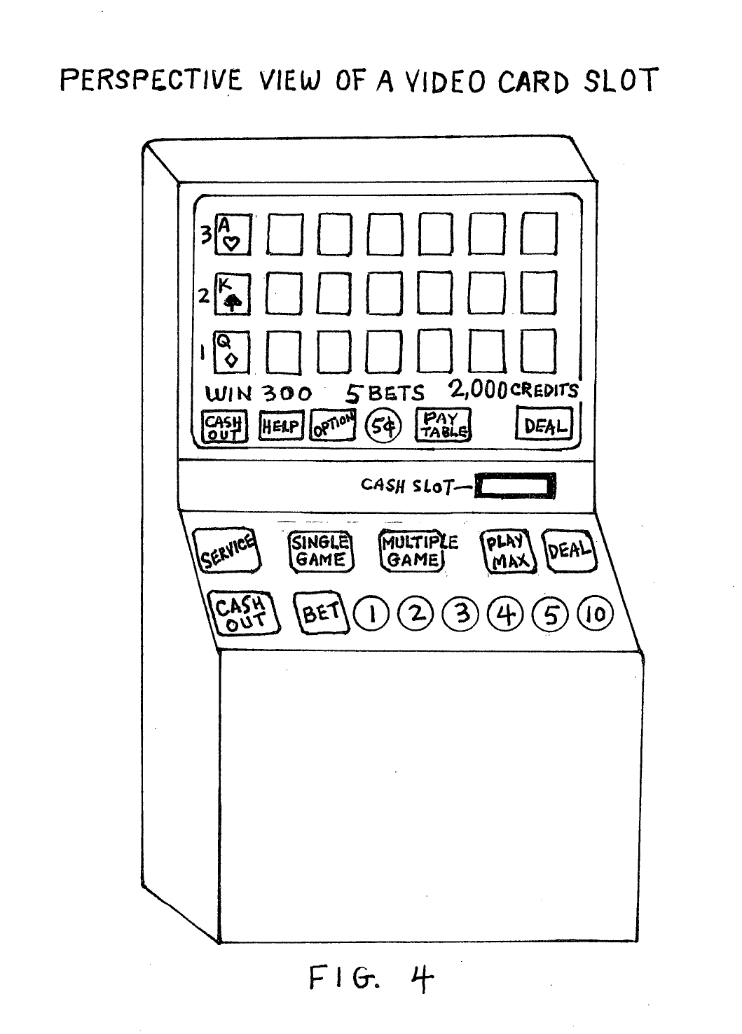

1. Card spot: The spot is used to display the cards of each hand; and it is preferably located in the middle and top of the screen as seen on the screen in FIG. 4.

2. Option spot or More Games: It is where a player may select or make changes to the games, denominations, number of hands, and number of bets of the game play as seen on the screen in FIG. 4.

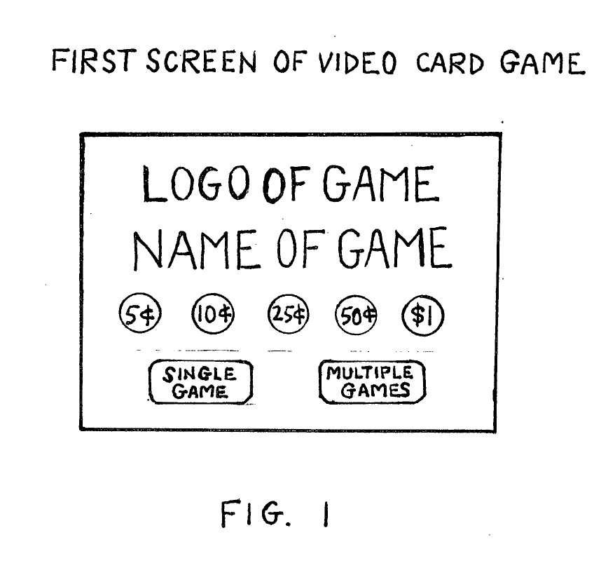

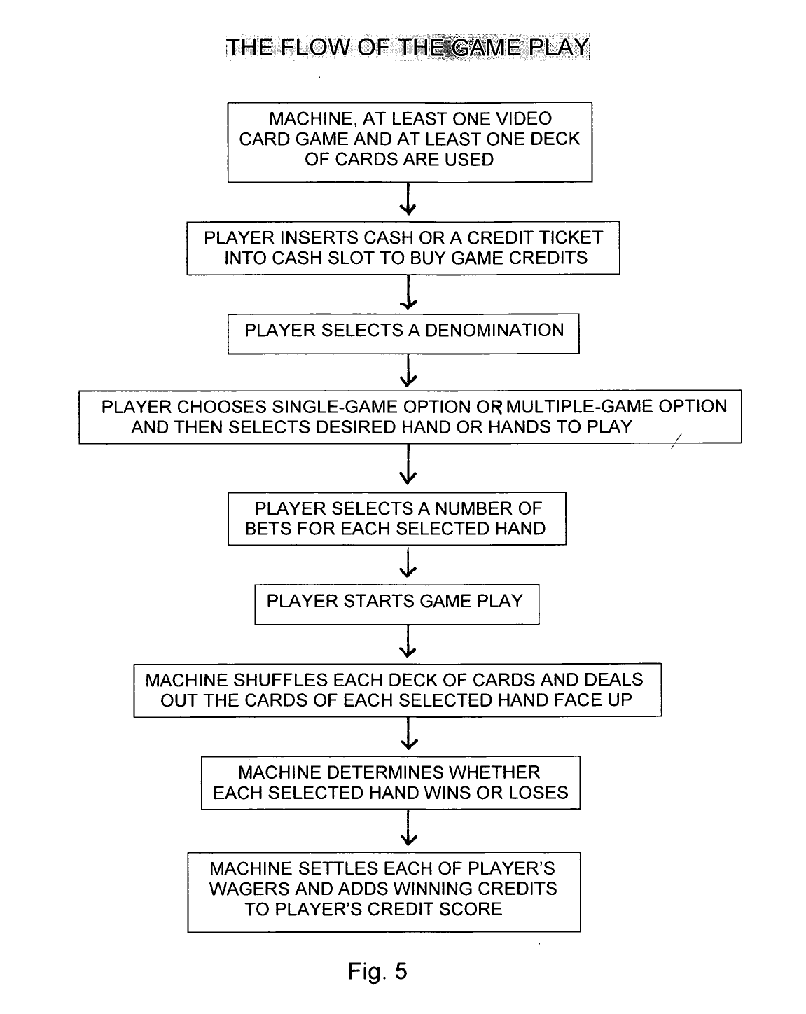

3. Denomination spot or spots: The spots (usually on the starting screen or first screen of the game play) display various denominations for a player to choose and the spot (usually on the screen during the game play such as on the screen in FIG. 1) shows what denomination is being played (as seen on the screen in FIG. 5).

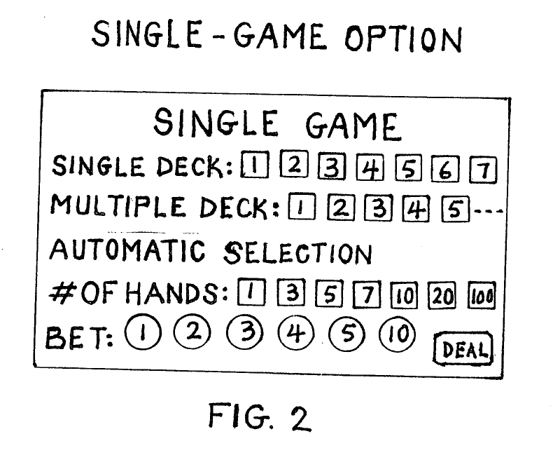

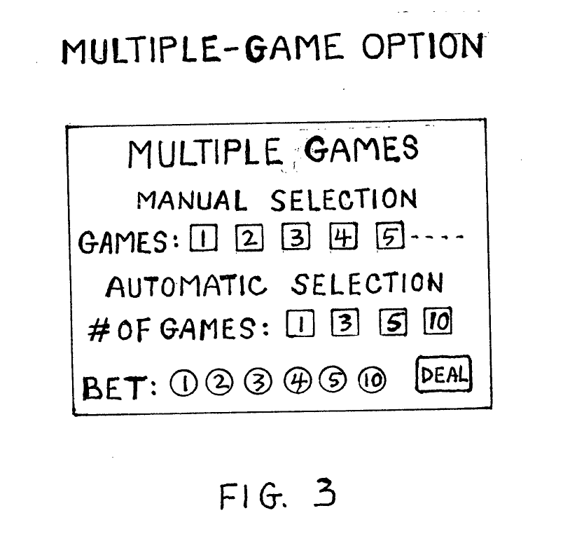

4. Hand spot or Game spot: This spot shows many hands or games and the hand or game number of each hand or game the player has selected to play as seen on the screen in FIG. 2 and FIG. 3.

5. Bet spot: This spot shows many bets the player has selected to play as seen on the screen in FIG. 2, FIG. 3 and FIG. 4.

6. Pay Table or See Pays spot: It is where a player may retrieve and read the pay table of a game as seen on the screen in FIG. 4.

7. Win or Pay spot: The spot that shows how many credits the player wins at any given round of play as seen on the screen in FIG. 4.

8. Credit Score or Cash spot: It shows the number of credits available for the player to use or cash out as seen on the screen in FIG. 4.

9. Deal spot: It is the spot a player start a play or a new play as seen on the screen in FIG. 4.

10. Cash-Out spot: It is where the player requires to cash out, ending the game play as seen on the screen in FIG. 4.

11. Help spot: It is where a player may find the instruction of how to play the game as seen on the screen in FIG. 4.

All above spots 2 to 11 are preferably placed at the bottom of the screen.

The keyboard or key panel of the slot may encompass some or all of the following buttons:

1. Single Game button: It is a button that a player may select the slot using one video card game as seen on the key panel in FIG. 4.

2. Multiple Games button: The button that a player may select the slot using multiple video card games as seen on the key panel in FIG. 4.

3. Bet buttons: There are at least three but preferably seven Bet buttons for a player to choose to place bets on each hand or game, and they are “Bet,” “1,” “2,” “3,” “4,” “5,” and “10” (as seen on the key panel in FIG. 4).

4. Play Max or Bet Max button: It is the shortcut that a player selects to place a maximum number of Bets on each hand as seen on the key panel in FIG. 4.

5. Deal button: It is where a player starts a play or a new play as seen on the key panel in FIG. 4.

6. Cash-out button: It is where a player wants to cash out and quit playing as seen on the key panel in FIG. 4. And

7. Service button: It is where a player calls for services as seen on the key panel in FIG. 4.

The Use of a Computer:

The method and apparatus for playing at least one video card game on a computer or the Internet uses a number of things, including a computer, at least one video card game, at least one deck of cards (electronic cards, not physical cards), a monitor or screen, a keyboard, and a mouse. The screens of the computer may be designed to look largely identical or similar to the screens of the slot version.

The computer machine or computer processor has the capability or is programmed to electronically and randomly shuffle one deck of cards and, two or more individual decks of cards simultaneously, to deal out a number of selected hands of selected number of cards each at any given round of play, to determine whether the hand or hands (game or games) win or lose, to settle the wager or wagers of winning hand or hands and losing hand or hands, keep track of the player's credit score.

The Use of an Electronic Device:

The method and apparatus for playing at least one video card game on an electronic device uses an apparatus. The apparatus includes an electronic device (machine) using at least one video card game and at least one deck of cards, a screen or monitor, a key panel or keyboard. The screens and key panel of an electronic device may be configured both to look largely identical or similar to the screens of the slot machine and to function largely like the slot machine does.

The Option of Using at Least One Deck of Cards (Electronic Cards, not Physical Cards):

At least one standard poker deck of cards is used; wherein the deck of cards may be a standard deck of 52 cards; or wherein the deck of cards may be a standard deck of 52 cards with at least one Joker card, wherein the Joker may be used either (1) as any card or (2) as an Ace or to complete a Straight or Flush; or wherein the deck of cards may be a standard poker deck of 52 cards, wherein four cards of any 4 of a kind may be wild cards, which may be used as any card, such as 4 Deuces are wild. Alternatively, any appropriate deck of cards may be used.

The Option of Using at Least One Video Card Game:

The method and apparatus for playing at least one video card game may be designed to play one or more hands with one same video card game or to play one or more various video card games simultaneously. Each of the video card game may be any game that is played with at least one card per hand. The games may be new games and/or existing games.

The Option of Using an Amazing Pool of Multiple Decks of Cards:

Amazing Pool of Multiple Decks of Cards is a pool that preferably includes one or more identical decks of cards or separate decks of cards of other games or hands (such as there are three hands in 3-play draw poker game, hand 1 is the main hand or first hand, hand 2 and 3 are other hands) played in the last round of play, from which a player may replace the deck of cards used in the game he just finishes playing with one selected deck of cards from the pool.

Usually, when a player is unhappy with a machine, the player would look around to find another machine of same game to play. Replacing the deck of cards used in the game with one deck of cards selected from the pool is just like changing one machine with another machine of the same game. Choosing the Option of Using Amazing Pool of Multiple Decks of Cards can save a player the trouble of looking around to find another machine of same game and the rage when the player does not fine one. It also can save slot operators the high cost and valuable space of placing additional machines for the reasons; especially, if one deck of cards used is equal to the value of one machine, then a pool of 10 decks of cards could save a slot operator the cost and valuable space of carrying 10 machines, 100 decks replaces 100 machines.

This option is preferably available to a player after the completion of a play or before a next new play. It is shown on the screen, preferably on the bottom the screen. If the player wants to utilize the option, the player touches the option spot before starting the next new play; if not, the player starts the next new play after the completion of the play.

The Option of Using an Amazing Pool of Multiple Decks of Cards may be incorporated in any new or existing video poker game to obtain said benefits.

The Option of Using a Pool of Other Identical Games:

A pool of other identical games is a pool that includes one or more other games identical to the game the player currently plays, and each game, including the game the player currently plays, uses each separate identical deck of cards.

This option is preferably available to a player after the completion of a play. Whenever the player wants to change the machine for the same game, the player may select this option picking one other game from the pool, instead of having the trouble looking around for another machine of the same game. Alternatively, this option may be made to be available to a player before a player starting the player's first play.

The Option of Using a Pool of Other Identical Games possibly produces the same benefits as the Option of using a Pool of Multiple Decks of Cards does. It may also be incorporated into any new or existing video poker game to obtain said benefits.

The Option Spot or Button:

The Option Spot shown on the screen is available to a player after the completion of a play. When the player touches the option spot on the screen or hits the option button on the keyboard, it will lead to a screen including either The Option of Using Amazing Pool of Multiple Decks of Cards or The Option of Using a Pool of Other Identical Games, or both.

Below are games that may be incorporated into the present invention.

7-Card Thrill Video Game:

The game uses 52 cards and 1 Joker; the Joker may be used as an Ace or to form a Straight or Flush. This game offers a player 3 separate bets: Poker Bet, Pair Of Aces Or Better Bet, and Bonus Bet. Before cards are dealt, a player must place either a Poker bet or Pair Of Aces Or Better bet, or both, then the player may make a Bonus bet.

Poker Bet:

The player's Poker wager wins if the player's best 5-card hand (out of your 7 cards) beats or ties banker's best 5-card hand or if the player is dealt a 7-Card Straight Flush hand or a 7-Card 9-High hand.

The player's winning wager is paid 1 to 1, unless the banker's losing hand is less than King-Queen High, then it is paid half (½).

Pair Aces or Better Bet

The player's Pair Aces Or Better wager wins if the player's best 5-card hand is a pair of Aces, Two Pair, 3 of a Kind, Straight, Flush, Full House, 4 of a Kind, Straight Flush, Royal Flush, 5 Aces, 7-Card Straight Flush or 7-Card 9-High. The player's wager loses if the player's hand is not one of the winning hand.

The player's winning wager is paid 1 to 1; and it is paid 3 to 2 if there are two or more Aces in the player's seven dealt cards.

Bonus Bet:

The player's Bonus wager wins if the player's best 5-card hand is 3 of a Kind, Straight, Flush, Full House, 4 of a Kind, Straight Flush, Royal Flush, 5 Aces, of if the player is dealt 7-Card Straight Flush or 7-Card 9-High. The player's wager loses if the player's hand is not one of the winning hands.

The player's winning wager is paid according to the following pay table:

| | |
|---|---|
| 7-Card Straight Flush no Joker | 8,000 to 1 |
| 7-Card Straight Flush with Joker | 2,000 to 1 |
| 5 Aces | 800 to 1 |
| Royal Flush | 200 to 1 |
| Straight Flush | 60 to 1 |
| 4 of a Kind | 40 to 1 |
| Full House | 5 to 1 |
| Flush | 4 to 1 |
| 3 of a Kind or Straight | 2 to 1 |
| 7-Card 9 High | 10 to 1 |

Maximum Total Payout (such as $25,000) per Bonus bet may applied.
Conventional poker rankings used, but A2345 is the 2^{nd} highest Straight.
Before cards are dealt, a player must place either a Poker bet or Pair Of Aces Or Better bet, or both, then the player may make a Bonus bet.

Wild 7 Card Thrill Video Game:

Wild 7 Card Stud is a 7-card stud game and uses one standard poker deck of 52 cards plus one Joker, which may be used as any card. In any given round of play, two or up to maximum seven sets of seven card hands may be dealt depending on how many hands a player wants to play. The game offers three separate bets: Poker Bet, Pair Aces Or Better Bet and Bonus Bet. Before cards are dealt, a player must place either a Poker bet or Pair Of Aces Or Better bet, or both, then the player may make a Bonus bet.

Poker bet is a bet that a player's best 5-card hand plays against the banker's best 5-card hand, if the player's best 5-card hand ranks higher than the banker's, the player's bet wins and is paid either Even Money (1 to 1) if the banker's losing hand is King-Queen High or better, or half (½) of the player's bet if the banker's losing hand is less than King-Queen High; if the player's best 5-card hand ranks the same as the banker's, the player's bet is a tie or a push; and if the player's best 5-card hand ranks lower than the banker's, the player's bet loses.

Pair of Aces or Better bet wins if the player's best 5-card hand is a pair of Aces, Two Pair or better (3 of a Kind, Straight, Flush, Full House, 4 of a Kind, Straight Flush, Royal Flush, 5 of a Kind, 7-Card Straight Flush) and is paid Even Money, 1 to 1; this bet loses if the player's best 5-card hand is not one of the above winning hand.

Bonus bet wins if the player's best 5-card hand is Two Pair or better, and is paid according to a predetermined pay table such as the following table:

| Hand | Payoff Odds | % Return |
|---|---|---|
| 7-Card Straight | 4,000 for 1 | (4,000 × 0.0001467 = 0.5868 = 0.59) |
| Flush | | |
| Royal Flush | 500 for 1 | (500 × 0.0029194 = 1.4597 = 1.46) |
| 5 of a Kind | 400 for 1 | (400 × 0.0095132 = 3.805 = 3.80) |
| Royal Flush with | 300 for 1 | (300 × 0.0140078 = 4.2 = 4.20) |
| Joker | | |
| Straight Flush | 50 for 1 | (50 × 0.1199094 = 5.9925 = 5.99) |
| 4 of a Kind | 20 for 1 | (20 × 0.7272620 = 14.55 = 14.55) |
| Full House | 5 for 1 | (5 × 3.8906346 = 15.562 = 15.56) |
| Flush | 4 for 1 | (4 × 3.9101489 = 15.6404 = 15.64) |
| Straight | 2 for 1 | (2 × 7.1906828 = 14.3814 = 14.38) |
| 3 of a Kind | 2 for 1 | (2 × 8.6382730 = 17.2766 = 17.28) |
| | | Total 93.45 |

100% − 93.45% = 6.55% house advantage
Hit frequency is 44.89%

Wild 7 Card Stud Video Game:

Wild 7 Card Stud is a 7-card stud game and uses one standard poker deck of 52 cards plus one Joker, which may be used as any card. In any given round of play, two or up to maximum seven sets of seven card hands may be dealt depending on how many hands a player wants to play. Before cards are dealt, a player must make a bet.

The player's bet wins if the player's best 5-card hand is 3 of a Kind or better, and is paid according to a predetermined pay table such as one of the following tables:

PAY TABLE 1

| Hand | Payoff Odds | % Return |
|---|---|---|
| 7-Card Straight | 4,000 for 1 | (4,000 × 0.0001467 = 0.5868 = 0.59) |
| Flush | | |
| Royal Flush | 500 for 1 | (500 × 0.0029194 = 1.4597 = 1.46) |
| 5 of a Kind | 400 for 1 | (400 × 0.0095132 = 3.805 = 3.80) |
| Royal Flush with | 300 for 1 | (300 × 0.0140078 = 4.2 = 4.20) |
| Joker | | |
| Straight Flush | 50 for 1 | (50 × 0.1199094 = 5.9925 = 5.99) |
| 4 of a Kind | 20 for 1 | (20 × 0.7272620 = 14.55 = 14.55) |
| Full House | 4 for 1 | (5 × 3.8906346 = 15.562 = 15.56) |
| Flush | 3 for 1 | (3 × 3.9101489 = 11.7306 = 11.73) |
| Straight | 1 for 1 | (1 × 7.1906828 = 7.1907 = 7.19) |
| 3 of a Kind | 1 for 1 | (1 × 8.6382730 = 8.6383 = 8.64) |
| Two Pair | 1 for 1 | (1 × 20.3923524 = 20.3923 = 20.39) |
| | | Total 94.09 |

100% − 94.09% = 5.91% house advantage
Hit frequency is 24.5%

PAY TABLE 2

| Hand | Payoff Odds | % Return |
|---|---|---|
| 7-Card Straight | 5,000 for 1 | 5,000 × 0.0001467 = 1.4670 = 0.73) |
| Flush | | |
| Royal Flush | 600 for 1 | (600 × 0.0029194 = 1.7514 = 1.75) |
| 5 of a Kind | 400 for 1 | (400 × 0.0095132 = 3.805 = 3.80) |
| Royal Flush with | 300 for 1 | (300 × 0.0140078 = 4.2 = 4.20) |
| Joker | | |
| Straight Flush | 50 for 1 | (50 × 0.1199094 = 5.9925 = 5.99) |
| 4 of a Kind | 20 for 1 | (20 × 0.7272620 = 14.55 = 14.55) |
| Full House | 4 for 1 | (5 × 3.8906346 = 15.562 = 15.56) |
| Flush | 3 for 1 | (3 × 3.9101489 = 11.7306 = 11.73) |
| Straight | 1 for 1 | (1 × 7.1906828 = 7.1907 = 7.19) |
| 3 of a Kind | 1 for 1 | (1 × 8.6382730 = 8.6383 = 8.64) |
| Two Pair | 1 for 1 | (1 × 20.3923524 = 20.3923 = 20.39) |
| | | Total 94.53 |

100% − 94.54% = 5.47% house advantage
Hit frequency is 44.89%

PAY TABLE 3

| Hand | Payoff Odds | % Return |
|---|---|---|
| 7-Card Straight | 5,000 for 1 | (5,000 × 0.0001467 = 1.4670 = 0.73) |
| Flush | | |
| Royal Flush | 600 for 1 | (600 × 0.0029194 = 1.7514 = 1.75) |
| 5 of a Kind | 400 for 1 | (400 × 0.0095132 = 3.805 = 3.80) |
| Royal Flush with | 300 for 1 | (300 × 0.0140078 = 4.2 = 4.20) |
| Joker | | |
| Straight Flush | 60 for 1 | (60 × 0.1199094 = 7.1915 = 7.19) |
| 4 of a Kind | 20 for 1 | (20 × 0.7272620 = 14.55 = 14.55) |
| Full House | 4 for 1 | (5 × 3.8906346 = 15.562 = 15.56) |
| Flush | 3 for 1 | (3 × 3.9101489 = 11.7306 = 11.73) |
| Straight | 1 for 1 | (1 × 7.1906828 = 7.1907 = 7.19) |
| 3 of a Kind | 1 for 1 | (1 × 8.6382730 = 8.6383 = 8.64) |
| Two Pair | 1 for 1 | (1 × 20.3923524 = 20.3923 = 20.39) |
| | | Total 95.73 |

100% − 94.54% = 4.27% house advantage
Hit frequency is 44.89%

PAY TABLE 4

| Hand | Payoff Odds | % Return |
|---|---|---|
| 7-Card Straight | 5,000 for 1 | (5,000 × 0.0001467 = 1.4670 = 0.73) |
| Flush | | |
| Royal Flush | 600 for 1 | (600 × 0.0029194 = 1.7514 = 1.75) |
| 5 of a Kind | 500 for 1 | (500 × 0.0095132 = 4.756 = 4.76) |
| Royal Flush with | 300 for 1 | (300 × 0.0140078 = 4.2 = 4.20) |
| Joker | | |
| Straight Flush | 60 for 1 | (60 × 0.1199094 = 7.1915 = 7.19) |
| 4 of a Kind | 20 for 1 | (20 × 0.7272620 = 14.55 = 14.55) |
| Full House | 4 for 1 | (5 × 3.8906346 = 15.562 = 15.56) |
| Flush | 3 for 1 | (3 × 3.9101489 = 11.7306 = 11.73) |
| Straight | 1 for 1 | (1 × 7.1906828 = 7.1907 = 7.19) |
| 3 of a Kind | 1 for 1 | (1 × 8.6382730 = 8.6383 = 8.64) |
| Two Pair | 1 for 1 | (1 × 20.3923524 = 20.3923 = 20.39) |
| | | Total 96.68 |

100% − 96.68% = 3.32% house advantage
Hit frequency is 44.89%

5-Card Video Game:

The objective of this game is to obtain one of predetermined winning hands. This game uses one standard poker deck of cards. After A player's wagers wins if the player's hand one of predetermined winning hands; the player's wager loses if the hand is not one of the predetermined winning hands; the player's winning wager is paid according to either a predetermined pay table or a predetermined payout odds; alternatively, it may be paid according to a progressive pay table; or it may be paid according to the combination of a predetermined pay table and a progressive pay table. Either one of the following pay table may be the predetermined pay table:

TABLE 1

| Hand | For 1 |
|---|---|
| Royal Flush | 4000 |
| Straight Flush | 500 |
| 4 Aces + J-K | 1000 |
| 4 Aces | 400 |
| 4 J-K + J-A | 200 |
| 4 2-10 | 100 |
| Full House | 16 |
| Flush | 10 |
| Straight | 7 |
| 3 of a Kind | 5 |
| Two Pair | 4 |
| Pair Q-A | 2 |
| Pair 2-J | 1 |

House Advantage is about 6%.

TABLE 2

| Hand | For 1 |
|---|---|
| Royal Flush | 4000 |
| Straight Flush | 500 |
| 4 Aces + J-K | 1000 |
| 4 Aces | 400 |
| 4 J-K + J-A | 200 |
| 4 2-10 | 100 |
| Full House | 16 |
| Flush | 12 |
| Straight | 9 |
| 3 of a Kind | 5 |
| Two Pair | 4 |
| Pair Q-A | 2 |
| Pair 2-J | 1 |

House Advantage is about 4.93%.

TABLE 3

| Hand | For 1 |
|---|---|
| Royal Flush | 4000 |
| Straight Flush | 500 |
| 4 Aces + J-K | 1000 |
| 4 Aces | 400 |
| 4 J-K + J-A | 200 |
| 4 2-10 | 100 |
| Full House | 16 |
| Flush | 10 |
| Straight | 7 |
| 3 of a Kind | 6 |
| Two Pair | 4 |
| Pair Q-A | 2 |
| Pair 2-J | 1 |

House Advantage is about 3.9%.

TABLE 4

| Hand | For 1 |
|---|---|
| Royal Flush | 4000 |
| Straight Flush | 500 |
| 4 Aces + J-K | 1000 |
| 4 Aces | 400 |
| 4 J-K + J-A | 200 |
| 4 2-10 | 100 |
| Full House | 16 |
| Flush | 10 |
| Straight | 8 |
| 3 of a Kind | 5 |
| Two Pair | 4 |
| Pair Q-A | 2 |
| Pair 2-J | 1 |

House Advantage is about 3.5%.

7-Card Stud Video Game:

The objective of this game is to obtain one of predetermined winning hands. This game uses one standard poker deck of cards. To play the game, a player must make a bet before the cards are dealt. The player's wagers wins if the player's hand one of predetermined winning hands; the player's wager loses if the hand is not one of the predetermined winning hands; the player's winning wager is paid according to either a predetermined pay table or a predetermined payout odds; alternatively, it may be paid according to a progressive pay table; or it may be paid according to the combination of a predetermined pay table and a progressive pay table.

6-Card Stud Video Game:

The objective of this game is to obtain one of predetermined winning hands. This game uses one standard poker deck of cards. To play the game, a player must make a bet before the cards are dealt. The player's wagers wins if the player's hand one of predetermined winning hands; the player's wager loses if the hand is not one of the predetermined winning hands; the player's winning wager is paid according to either a predetermined pay table or a predetermined payout odds; alternatively, it may be paid according to a progressive pay table; or it may be paid according to the combination of a predetermined pay table and a progressive pay table.

4-Card Stud Video Game:

The objective of this game is to obtain one of predetermined winning hands. This game uses one standard poker deck of cards. To play the game, a player must make a bet before the cards are dealt. The player's wagers wins if the player's hand one of predetermined winning hands; the player's wager loses if the hand is not one of the predetermined winning hands; the player's winning wager is paid according to either a predetermined pay table or a predetermined payout odds; alternatively, it may be paid according to a progressive pay; or it may be paid according to the combination of a predetermined pay table and a progressive pay table.

The Use of at Least One Deck of Cards:

The method of playing at least one video poker game uses at least one standard poker deck of electronic cards (not physical cards). The deck of cards may be a standard deck of 52 cards; or the deck of cards may be a standard deck of 52 cards with at least one Joker card, wherein the Joker may be used either (1) as any card or (2) as an Ace or to complete a Straight or Flush; the deck of cards may be a standard poker deck of 52 cards, wherein four cards of any 4 of a kind may be assigned as wild cards, which may used as any card, such as Deuces are wild.

The Method and Apparatus for Playing a Video Card Game of Single-Game Play and the Preferred Embodiments:

The method and apparatus for playing a video card game of single-game play involving at least one player and using one video card game is played as follows:

1. A slot machine or computer or a an electronic device, hereinafter defined as “the machine,” is used, which is programmed or configured to run, manage, and complete game play of one hand, or game plays of up to a maximum number of hands, such as 3, 5, 10, 25, 50 or 100 hands, of one same video card game simultaneously.

2. The player may select a denomination he or she wants to play from a list of various amounts, such as a list of 5¢, 10¢, 25¢, 50¢ and $1. Alternatively, any list of various amounts may be used.

3. A pool of video card games of single-game play is provided to the player, such as 7-Card Thrill, Wild 7-Card Thrill, Wild 7-Card Stud, 5-Card Stud, 7-Card Stud, 6-Card Stud, and 4-Card Stud, etc.

4. The player may select one said game from the pool to play with either single deck of cards or multiple separate decks of cards.

The single deck of cards or each separate deck of cards may be a deck of cards may be a standard deck of 52 cards, or it may be a standard deck of 52 cards with at least one Joker, wherein the Joker may be used either (1) as any card or (2) as an Ace or to complete a Straight or Flush; or it may be a standard poker deck of 52 cards, wherein four cards of any 4 of a kind may be wild cards, which may be used as any card, such as 4 Deuces are wild. Alternatively, it may be any appropriate deck of cards.

Game Played with Single Deck of Cards: The game played with single deck of cards gives the player an option to select a particular hand or hands to play from a small pool of hands (the pool of hands generally is the maximum number of hands that one deck of cards can accommodate; for example, in a video 7-card game, there are maximum seven hands dealt from one deck of 52 cards, therefore, the maximum number of hands of the pool are seven hands; in a video 5-card game, the maximum number of hands of the pool are ten hands).

In a game (wherein a player's hand plays against a pay table) that has only player hands and no banker hand, a player can select one hand or up to the maximum number of hands from the pool of hands to play. The player himself can select any particular hand or hands to play from a pool of dealt hands, or the player can have the machine choosing the number of hands he or she wanting to play by touching the number of hands under Automatic Selection spot on the monitor screen (FIG. 2) or hitting the number of hands of Automatic Selection button on the key board if there is one; the machine then deals out the number of hands that the player wants.

In a game that includes player hands and a banker hand, a player can select one hand or up to the maximum number of hands from the pool of available hands to play. When the player decides that he himself selects any particular hand or hands to play from a pool of available hands, either one of the following rules may be incorporated to be part of the game: (1) The player may select any particular hand or hands to play from a pool of available hands and selects one hand to be the banker hand. (2) The player may select any particular hand or hands to play from a pool of available hands and the machine selects one hand to be the banker hand according to the rules of the game (for example, there are seven dealt hands, hands 1 to 7, the banker hand may be predetermined by the rules of the game to be hand 1, or any other hand such as hand 7). If the player wants the machine helping him to select a hand or hands to play from a pool of available hands, either one of the following rules may be incorporated to be part of the game: (1) The player hand or hands will be dealt first and then the banker hand will be dealt last. (2) The banker hand will be dealt first and then the player hand or hands will be dealt last.

Multiple Decks of Cards: The game using multiple decks of same cards gives the player a chance to select two or up to a maximum number of hands (such as 3, 5, 10, 25, 50 or 100 hands) to play, and each hand is preferably dealt from each separate deck of cards. For example, if the player selects 100 hands to play, each of his 100 selected hands will be dealt from each of 100 separate decks of cards). Preferably, games without a banker hand are chosen for this option. Alternatively, the player may be given the option to choose the deck or decks of cards for the hand or hands he wants to play from the pool of decks of cards; the pool of decks of cards may be two or up to any number of decks of cards.

5. The player buys or gets game credits to be used for making bets; wherein in a slot game, the player may insert cash or a credit ticket into cash-insert slot to get game credits; wherein in a computer game or any other electronic device game, the player may obtain game credits by any appropriate mean, through any appropriate way, or through any appropriate place such as getting game credits from the computer or the electronic device.

7. The player selects the number of bets or betting units for each selected hand, which may be one bet or up to the maximum number of bets that the game allows.

8. The player activates or starts the game play.

9. The machine deducts the total game credits of said bet or bets or total betting units from the credit score or available credit.

10. The machine electronically, randomly, and thoroughly shuffle each deck of cards, and then deal them out on the screen, only the selected hands of the predetermined number of cards each (such as 5 selected hands of seven cards each), preferably face up.

11. If the game played requires the player to make any appropriate decision, such as discarding cards and drawing cards, fold or play out the hand, arranging the cards into a number of hands, the player must complete the requirement(s).

12. The machine determines whether each of the player's hands wins or loses according to rules of the game, such as a rules of game wherein each of the player's bets wins if the player's hand is one of the predetermined hands is determined according to rules of the game, wherein each of the player's losing hand is determined according to the rules of the game; wherein the predetermined winning hands may be hands that are based on only conventional poker hands, or only point-count hands of Baccarat (point-count hands of Baccarat consists of 0, 1, 2, 3, 4, 5, 6, 7, 8 and 9), or the combination of conventional poker hands and point-count hands of Baccarat. Alternatively, hands that are based on any appropriate ranking hands may be used.

13. The machine settles or resolves the player's wager or wagers according to rule of the game. Such as the rules of the game is that each of the player's losing hands gets no pay; wherein each of the player's winning hands is paid according to either a predetermined pay table or a predetermined payout odds. Alternatively, each of the player's winning hands may be paid according to a combination of a predetermined pay table and a progressive pay table or each of the player's winning hands may be paid according to only a progressive pay table.

14. The machine adds the player's winning credits to the player's credit score. And

15. Either the Option of Using an Amazing Pool of Multiple Decks of Cards or the Option of Using a Pool of Other Identical Games is shown on the screen and is available for the player to choose for next new play after the completion of the play. Alternative, an “Option” spot or “Choice” spot (or any other named called) on the screen after the completion of the play. Touching this spot will lead to the screen showing either the Option of Using an Amazing Pool of Multiple Decks of Cards or the Option of Using a Pool of Other Identical Games, and the player may make the player's choice.

Each video poker game used in the present invention may be an existing game or a newly invented game that is played with at least one card per hand, preferably five or seven cards per hand. The method and apparatus for playing single video card game may be configured or programmed to play on a lot machine, the Internet, a computer using gaming software, an electronic device, or on a surface such as a casino-type card table.

The Method and Apparatus for Playing at Least One Video Card Game of Multiple-Game Play and the Preferred Embodiments:

The method and apparatus for playing at least one video card game of multiple-game play involving at least one player is played as follows:

1. A slot machine or computer or a an electronic device, hereinafter defined as “the machine,” is used, which is programmed or configured to run, manage, and complete a game play of one game, or game plays of up to a maximum number of various games simultaneously, such as 3, 5, 10, 25, 50 or 100 games.

2. The player may select a denomination he or she wants to play from a list of various amounts, such as a list of 5¢, 10¢, 25¢, 50¢ and $1. Alternatively, any list of various amounts may be used.

3. A pool of various video card games of multiple-game play is provided to the player; the pool may include at least one new game and/or at least one existing game, such as Wild 7-Card Stud, 5-Card Stud, 7-Card Stud, 6-Card Stud, and 4-Card Stud; the various video card games used are preferably to be games of chance.

4. A player buys or gets game credits to be used for making bets; wherein in a slot game, the player may insert cash or a credit ticket into cash-insert slot to get game credits; wherein in a computer game or any other electronic device game, the player may obtain game credits by any appropriate mean, through any appropriate way, or through any appropriate place such as getting game credits from the computer or the electronic device.

5. The player may select at least one game from the pool of various video card games to play; the pool of various video card games may contain one or up to a maximum number of various video card games that the player is allowed to play, such as the maximum number of various video card games are 10 various games or 100 various games; and each game is preferably dealt from each separate deck of cards. For example, if the player selects 100 various video card games to play, each of his 100 selected various video card games will be dealt from each of 100 separate decks of cards. Preferably, each game consists of one hand.

6. The player selects the number of bets or betting units for each selected game, which be one bet or up to the maximum number of bets that the player is allow to play.

7. The player activates or starts the game play.

8. The machine deducts the total game credits of said bet or bets or total betting units from the credit score or available credit.

9. The machine shuffles each separate deck of cards (electronic cards, not physical cards) and deal out a hand or hands of selected games; wherein each separate deck of cards may be a standard deck of 52 cards; or it may be a standard deck of 52 cards with at least one Joker, wherein the Joker may be used either (1) as any card or (2) as an Ace or to complete a Straight or Flush; or it may be a standard poker deck of 52 cards, wherein four cards of any 4 of a kind may be wild cards, which may be used as any card, such as 4 Deuces are wild. Alternatively, each separate deck of card may be any appropriate deck of cards.

10. If the game played requires the player to make any appropriate decision, such as discarding cards and drawing cards, fold or play out the hand, arranging the cards into a number of hands, the player must complete the requirement(s). If not, move to step 11.

11. The machine determines whether each of the player's hands wins or loses according to rules of the game;

12. The machine settles or resolves the player's bet or bets according to rules of the game. Such as the rules of the game is that each of the player's losing hands gets no pay; wherein each of the player's winning hands is paid according to either a predetermined pay table or a predetermined payout odds. Alternatively, each of the player's winning hands may be paid according to a combination of a predetermined pay table and a progressive pay table, or each of the player's winning hands may be paid according to only a progressive pay table.

13. The machine adds the player's winning credits to the player's credit score. And

14. Either the Option of Using an Amazing Pool of Multiple Decks of Cards or the Option of Using a Pool of Other Identical Games is shown on the screen and is available for the player to choose for next new play after the completion of the play. Alternatively, when there is an “Option” spot or “Choice” spot (or any other named called) appearing on the screen after the completion of the play; touching this spot will lead to the screen showing either the Option of Using an Amazing Pool of Multiple Decks of Cards or the Option of Using a Pool of Other Identical Games, and the player may make his or her choice for the next new play.

Each video poker game used in the present invention may be an existing game or a newly invented game that is played with at least one card per hand, preferably five or seven cards per hand. The method and apparatus for playing single video card game may be configured or programmed to play on a slot machine, the Internet, a computer using gaming software, an electronic device, or on a surface such as a casino-type card table.

The Method and Apparatus for Playing One Video Card Game and Preferred Embodiments:

A method and apparatus for playing multiple video card games involving at least one player is played as follows:

1. A slot machine or a computer or an electronic device, hereinafter defined as “the machine,” is used.

2. The player selects a denomination he or she wants to play from a list of various amounts.

3. A video card game, new or existing, is used.

4. The player buys or gets game credits to be used for making bets.

5. The player places a bet and activates a game play.

6. The machine deducts the total game credit of said bet from credit score.

7. At least one deck of electronic cards is used.

8. The machine shuffles the deck of cards and deals a hand of 5 cards face up.

9. The player acts appropriately upon the dealt hand or plays out the dealt hand.

10. The machine determines whether the player's bet wins or loses according to rules of the game.

11. The machine settles or resolves the player's bet according to rules of the game.

12. The machine adds the player's winning credits to the player's credit score, if any. And

13. Either the Option of Using an Amazing Pool of Multiple Decks of Cards or the Option of Using a Pool of Other Identical Games, or both, may be designed to be shown on the screen and is available for the player to choose for next new play after the completion of the play. Alternative, an “Option” spot or “Choice” spot (or any other named called) on the screen after the completion of the play; touching this spot will lead to the screen showing either the Option of Using an Amazing Pool of Multiple Decks of Cards or the Option of Using a Pool of Other Identical Games, and the player may make his or her choice.

Alternatively, either the Option of Using an Amazing Pool of Multiple Decks of Cards or the Option of Using a Pool of Other Identical Games, or both, may be designed to be shown on the screen and to be available for the player to choose for next new play after the completion of the play.

Three Types of Machines:

There are three types of machines may be created as follows:

First type of machine consists of the Method and Apparatus for Playing a Video Card Game of Single-Game Play and the Preferred Embodiments.

Second type of machine consists of the Method and Apparatus for Playing At Least One Various Video Card Game of Multiple-Game Play and the Preferred Embodiments. And

Third type of machine or game design combines the Method and Apparatus for Playing a Video Card Game of Single-Game Play and the Preferred Embodiments and the Method and Apparatus for Playing At Least One Various Video Card Game of Multiple-Game Play and the Preferred Embodiments.

Overall, the method and apparatus for playing at least one video card game of the present invention produces many benefits:

The present invention allows a player to pick one or more of the player's favorite games to play simultaneously—doubling the player's pleasure and enjoyment of playing a game.

The present invention allows a player to choose either use of single deck of cards or use of multiple separate decks of cards, and the right to select a player hand or hands for the player and the right to choose any hand to be a banker hand—giving the player a strong sense of control.

The present invention provides that a player may play as many hands or games as the player wants that the machine allows—significantly enhancing the player's chances of hitting big bonus hands.

Most of the games used in the present invention are games of chance; hence it would highly appeal to new players and the players who do not want to learn and play properly according to an optimal playing strategy.

The Option of Using an Amazing Pool of Multiple Decks of Cards and the Option of Using a Pool of Other Identical Games of the present invention would save both a player the trouble looking around for another machine of the same game and slot operators the cost and valuable space of carrying additional machines for that reason.

What I claim as my invention is:

1. A method and apparatus for playing at least one video card games involving at least one player comprising the steps of:
(a) providing a slot machine or a computer or an electronic device, hereinafter defined as “the machine”;
(b) the player selecting a denomination he or she wants to play from a list of various amounts;
(c) providing a pool of various video card games;
(d) the player selecting at least one video card games from the pool of various video card games;
(e) the player buying or getting game credits to be used for making bets;
(f) the player placing a bet or bets and activating a game play;
(g) the machine deducting the total game credit of said bet or bets from credit score;
(h) providing and shuffling at least one deck of electronic cards;
(i) dealing cards face up;
(j) the machine determining whether each of the player's bet or bets wins or loses, according to rules of the game;
(k) the machine settling or resolving the player's bet or bets; and
(l) the machine adding the player's winning credits to the player's credit score, if any.

2. A method and apparatus for playing one video card game involving at least one player comprising the steps of:
(a) providing a slot machine or a computer or an electronic device, hereinafter defined as “the machine”;
(b) the player selecting a denomination he or she wants to play from a list of various amounts;
(c) providing a pool of various video card games;
(d) the player selecting one video card game from the pool of various video card games;
(e) the player buying or getting game credits to be used for making bets;
(f) providing and shuffling one deck of electronic cards;
(g) dealing cards face down into one or multiple hands;
(h) the player selecting any hand or hands to be a player hand or hands to play, and selecting a hand to be the banker hand;
(i) the player placing a bet or bets and activating a game play;
(j) the machine deducting the total game credit of said bet or bets from credit score;
(k) the machine opening all hands;
(l) the machine determining whether each of the player's bet or bets wins or loses, according to rules of the game;
(m) the machine settling or resolving the player's bet or bets; and
(n) the machine adding the player's winning credits to the player's credit score, if any.

3. A method and apparatus for playing multiple video card games involving at least one player comprising the steps of:
(a) providing a slot machine or a computer or an electronic device, hereinafter defined as “the machine”;
(b) the player selecting a denomination he or she wants to play from a list of various amounts;
(c) providing a video card game;
(e) the player buying or getting game credits to be used for making bets;
(f) the player placing a bet and activating a game play;
(g) the machine deducting the total game credit of said bet from credit score;
(h) providing and shuffling one deck of electronic cards;
(i) dealing a hand of 5 cards face up;
(j) the player acting appropriately upon the dealt hand or playing out the dealt hand;
(j) the machine determining whether the player's bet wins or loses according to rules of the game;
(k) the machine settling or resolving the player's bet;
(l) the machine adding the player's winning credits to the player's credit score, if any; and
(m) providing either the Option of Using an Amazing Pool of Multiple Decks of Cards or the Option of Using a Pool of Other Identical Games, which is shown on the screen and is available for the player to choose for next new play after the completion of the play.
